(19) United States
(12) Patent Application Publication
(10) Pub. No.: US 2026/0274000 A1
(43) Pub. Date: Sep. 17, 2026

(54) Removable grip device for a motor vehicle wheel

(71) Applicant: Priam LECOMTE, Hanches (FR)

(72) Inventor: Priam LECOMTE, Hanches (FR)

(21) Appl. No.: 19/167,085

(22) PCT Filed: Mar. 12, 2024
(86) PCT No.: PCT/EP2024/056579

§ 371 Date: Sep. 19, 2025

(30) Foreign Application Priority Data
Mar. 21, 2023 (FR) FR2302626

(51) Int. Cl. B60B 15/22

(52) U.S. Cl. CPC B60B 15/22

(57) ABSTRACT

A removable grip device for a wheel. The device includes a main body and a tread portion. The tread portion has a plurality of pads, at least some of the pads including elements for holding the removable device on the wheel. The device also includes a plurality of arms connected to the main body and each bearing one of the pads, each arm being movable in translation on the main body.

### CROSS-REFERENCE TO RELATED APPLICATIONS

This Application is a Section 371 National Stage Application of International Application No. PCT/EP2024/056579, filed Mar. 12, 2024, and published as WO 2024/194097 A1 on Sep. 26, 2024, not in English, which claims priority to and the benefit of French Patent Application No. FR2302626, filed Mar. 21, 2023, the contents of which are incorporated herein by reference in their entireties.

### FILED OF THE DISCLOSURE

The field of the invention is that of the design and manufacture of motor vehicle equipment.

More specifically, the invention relates in particular to a removable grip device for a motor vehicle wheel.

### BACKGROUND

To increase the grip of vehicles on certain types of terrain, it is known to add grip devices on wheel tires, particularly on drive wheel tires.

For this purpose, two solutions coexist.

A first solution consists of integrating the grip devices directly on the tire.

By way of example, mention may be made of studded tires which comprise studs projecting from the tire tread to form spikes making it possible to create better grip on frozen, icy or snowy ground.

However, this first solution has a major drawback.

Indeed, when the vehicle fitted with such tires needs to drive on an asphalt road, the presence of the studs poses a substantial risk of damaging the asphalt surface.

Moreover, on some roads, studded tires are simply prohibited.

Therefore, to avoid damaging asphalt roads, it is necessary to change the tires according to the type of road driven on.

This then requires substantial time to change the tires and/or represents a substantial cost when the motorist is not equipped with the equipment for changing tires.

Furthermore, when motorists own two sets of tires, the latter are usually already mounted on rims.

In other words, the motorists have two sets of wheels that they swap according to the season.

However, this requires substantial storage space to store the set of wheels not in use.

A second solution consists of equipping the tires, temporarily, with removable grip devices.

These removable grip devices are particularly used occasionally to make it possible to increase the drivability of motor vehicles according to the type of terrain driven on.

For example, these removable grip devices take the form of chains intended to surround the tires of the vehicle wheels, particularly the drive wheels.

However, these removable grip devices are generally difficult to implement for motorists who only use them occasionally.

Consequently, it is common to see, on roadsides, motorists who are unsuccessful in fitting the removable grip devices and then must stop their journey, or request assistance from other motorists.

The difficulty of fitting removable grip devices is that it is generally necessary to hook the devices on either side of the wheel.

Access to the rear of the wheel, i.e. access to the part of the wheel located in the wheel housing, can be difficult, especially when the vehicle has already driven on a snowy or muddy road and the space in the wheel housing is dirty or even obstructed.

To address this issue, novel removable grip devices have been developed. These removable grip devices have a fastening on the wheel which is performed only on the outer part of the wheel, i.e. the easily accessible part.

The patent document published under number DE2710323 discloses such a removable grip device which comprises a main body intended to come into contact with a rim wall and a tread portion intended to partially cover the tread.

The tread portion comprises cleats intended to frame protrusions from the tire to prevent untimely removal of the device.

The device is clamped to the wheel by means of a tensioning system accessible from the outside of the wheel.

However, such a device has certain drawbacks.

Firstly, because tires have different patterns on the tread, it is necessary to have as many different devices as there can be tire patterns or references.

Indeed, because the patterns form grooves in different locations of the tread, the same cleat could be located in a groove for a first tire reference, and outside the groove for a second tire reference.

Thus, for two different tires, the same device is not compatible with being secured and making it possible increase wheel grip.

Secondly, when the tires are worn, the grooves outlined by the patterns may have rounded edges, or even a reduced depth, preventing the cleats from holding correctly.

Thus, even if the device is compatible with the reference of the worn tire, its hold on the tire, and therefore on the wheel, remains precarious, and the risk of detachment of the device becomes substantial, which can cause a loss of grip potentially leading to an accident.

### SUMMARY

An exemplary aspect of the present disclosure relates to a removable grip device for a motor vehicle wheel, the wheel having a rim topped with a tire having a tread, the device comprising a main body intended to come into contact with a rim wall and a tread portion intended to at least partially cover the tread, said tread portion having grip means, characterized in that the tread portion comprises a plurality of pads intended to be distributed over the length of the tread, at least some of the pads including means for holding the removable device on the wheel, the holding means comprising a flap capable of adopting a clamping position wherein it extends transversely to the pad and forms with the main body and the pad a clamping bridge intended to clamp the wheel, and in that the device also comprises a plurality of arms connected to the main body by a first end and each bearing one of the pads at a second end, each arm being movable in translation on the main body between:
a first position wherein the pads are intended to be moved away from the tread and the or each flap is intended to be moved away from the wheel, and
a second position wherein the pads are intended to be in contact with the tread and the or each flap is intended to be in contact with the wheel.

Thanks to the translational mobility of the arms on the main body, fitting the device on a motor vehicle wheel is facilitated.

Indeed, to fit the device on a vehicle wheel, or to remove it, it is simply necessary to position the arms in their first position. This moves the pads away from the tread, and each flap away from the wheel.

The user then simply needs to position the main body against the rim wall or, on the contrary, move the main body away from the rim wall to fit or, respectively, remove the device.

During fitting, once the main body is in contact with the rim wall, the user simply needs to position each arm in its second position to secure the device to the wheel.

Indeed, switching each of the arms from its first position to its second position causes the pads to come into contact with the tire tread, and also each flap to come into contact with the wheel.

Thus, each flap forms, together with the main body and its pad, a bridge which clamps the wheel.

The device is thus secured to the wheel and the vehicle can then drive on a difficult roads by having increased grip.

The user can thus, thanks to the device, increase the grip of their vehicle quickly and easily, without having to use tools.

According to an advantageous aspect, the or each flap is rotatably mounted on a pad between a free position wherein the flap extends the pad, in the first position of the arm, and the clamping position to form the clamping bridge, in the second position of the arm.

The rotational mobility of the flap on its pad makes it easier to fit the device on a wheel.

Indeed, in its free position, the flap does not impede the insertion of the device into a wheel housing, to make it possible to clamp said wheel.

Switching the arms from their first position to their second position then causes each flap to move into its clamping position from its free position, which results in the formation of the clamping bridges and ensures clamping of the wheel.

Thus, the user does not have to worry about positioning each of the flaps into its clamping position manually.

Fitting and removing the device are thus greatly facilitated.

According to another advantageous aspect, the holding means also comprise, for each flap, a spring strip extending on an inner face of the pad intended to come into contact with the tread, the strip being designed to pivot the flap from its free position to its clamping position, simultaneously with switching of the arm from its first position to its second position.

The presence of the spring strip makes it possible to automate the movement of the flap from its free position to its clamping position, or vice versa, according to the movement of the arms relative to the main body.

This then contributes to easy fitting and removal of the device.

Indeed, the user does not have to adopt difficult positions or get dirty by entering the wheel housing to reach and handle the flaps.

According to another advantageous aspect, each strip bears a finger intended to be inserted into a hole made in the pad to allow switching of the arms from their first position to their second position.

The finger thus forms a fool-proofing device to ensure correct fitting of the device on a wheel.

Indeed, in the event of poor positioning, the finger cannot then be inserted into a hole, which prevents the device from being fitted on the wheel.

According to another advantageous aspect, the device also comprises means for locking each arm in its second position.

The locking means make it possible to hold the device in place on a wheel during its use.

Indeed, vibrations associated with the vehicle tread can cause an involuntary movement of the arms from their second position to their first position, which would cause a detachment of the device relative to the wheel.

The locking means then prevent such a detachment.

According to another advantageous aspect, the main body comprises a plurality of sleeves each receiving an arm to guide it in translation relative to the main body.

Thanks to the guiding of the arms in the sleeves, the position of the pads on the tire tread is ensured.

This then prevents a risk of poor fitting of the device on the wheel, which could lead to damage to the device and, in the worst case, an accident caused by a lack of grip.

According to another advantageous aspect, the device also comprises, for each arm, means for returning the arm to its second position.

The return means ensure contact of the pads on the tread.

In the event of failure of the locking means, the return means ensure that the pads are kept in contact with the tire tread.

According to another advantageous aspect, the device also comprises means for setting the position of the pads on the second end of the arms.

The setting means make it possible to adapt the device to different wheel dimensions, and particularly to different wheel diameters.

Thus, the same device can be used on several vehicles each having a different wheel size.

This is particularly advantageous for families who own several vehicles, or who change vehicles, because they do not have to purchase a removable grip device for each vehicle.

According to another advantageous aspect, the setting means comprise a series of housings made on the arms and at least one piece integral with each pad and intended to be housed in one of the housings.

Such setting means are simple to manufacture and implement.

Indeed, the user simply needs to select the appropriate housing and insert the piece therein to immobilize the pad on the arm according to the diameter of the wheel on which the device is intended to be used.

According to another advantageous aspect, the device comprises means for moving the arms, the moving means comprising a disk rotatably mounted in the main body and having, for each arm, a cam race, each arm being coupled to a cam follower intended to cooperate with one of the cam races.

Such moving means make it possible to move each of the arms simultaneously.

Thus, by handling the disk, the user can move each of the arms and thus lock the device on a wheel.

Fitting the device on a wheel is then facilitated.

According to another advantageous aspect, each cam race has a first ending spaced apart from a center of rotation of the disk and corresponding to the first position of the arm, and a second ending close to the center of rotation and corresponding to the second position of the arm.

The two endings make it possible to limit the movement of the arms.

Indeed, when the cam followers are located in the first ending or in the second ending, rotational movement of the disk is prevented, which avoids damaging the device and/or the vehicle by striking the pads against the wheel housing.

Furthermore, the two endings allow the user to become aware, by passive feedback, that the arms are either in their first position or in their second position.

According to another advantageous aspect, the disk has an imprint and the device comprises a removable tool of complementary shape with the imprint to allow rotation of the disk.

The use of a removable tool makes it possible to secure the device and to facilitate its use.

Indeed, through its removable feature, the tool can be removed from the device when it is fitted on a wheel, which prevents accidental or malicious rotation of the disk which would trigger the movement of the arms from their second position to their first position and would then render the device free to move relative to the wheel.

Furthermore, the tool can make it possible to create a lever arm making it possible to facilitate the rotation of the disk and therefore switching of the arms from their first position to their second position, or vice versa.

According to another advantageous aspect, the device also comprises means for fastening to a rim, the fastening means comprising studs intended to cooperate with screws for fastening the rim to a hub, the studs being adjustable in depth to allow adaptation of the device to the width of the wheel.

The use of adjustable studs makes it possible to adapt the device to different rims.

Indeed, to stand out from other vehicles, manufacturers propose rims having different shapes and particularly different recesses relative to an outer face of the tire.

Thus, by setting the stud optimally, the device can be adapted to different rims, which limits the equipment requirements of a household, for example.

According to another advantageous aspect, the grip means comprise protrusions forming alternating troughs and peaks on the pad.

The presence of protrusions makes it possible to improve wheel grip by creating channels for ejecting loose material which makes wheel grip difficult.

For example, the ejection channels make it possible to receive and eject snow, sand or mud quickly and easily.

Furthermore, the protrusions make it possible to create a penetration of the device in soft ground, which improves the grip of the vehicle wheels and therefore the drivability of the vehicle.

### BRIEF DESCRIPTION OF THE DRAWINGS

Other features and advantages of the invention will appear more clearly upon reading the following description of a preferred embodiment of the invention, given as an illustrative and non-limiting example, and from the appended drawings described hereinafter.

FIG. 1 is a schematic perspective representation of a removable wheel grip device for a motor vehicle, according to the invention.

FIG. 2 is a schematic front view representation of the removable grip device according to the invention, being fitted on a motor vehicle wheel.

FIG. 3 is a schematic sectional representation of a detail of the removable grip device according to the invention, being fitted on a motor vehicle wheel.

FIG. 4 is a schematic sectional representation of a detail of the removable grip device according to the invention, in a storage configuration.

FIG. 5 is a schematic front view representation of a detail illustrating means for setting the removable grip device according to the invention.

FIG. 6 is a schematic sectional representation of a first embodiment of means for fastening the removable grip device according to the invention.

FIG. 7 is a schematic sectional representation of a second embodiment of means for fastening the removable grip device according to the invention.

FIG. 8 is a schematic representation of a detail of means for moving the removable grip device according to the invention.

### DETAILED DESCRIPTION OF ILLUSTRATIVE EMBODIMENTS

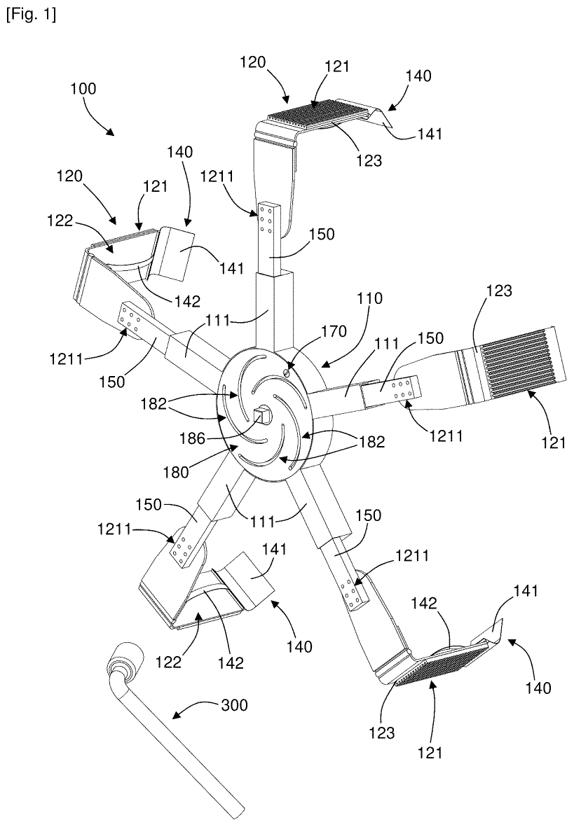

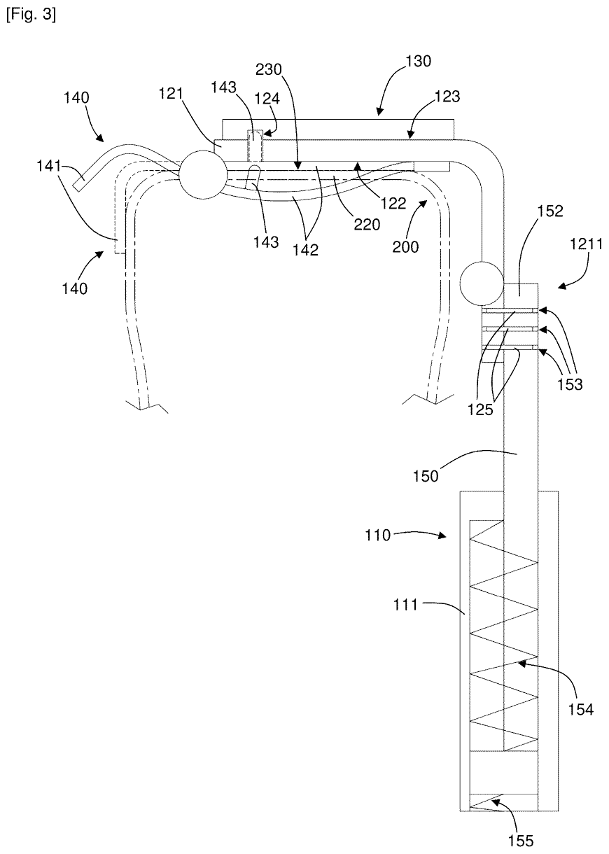

With reference to FIGS. 1 to 8, a removable grip device 100 according to the invention is described.

Such a device 100 makes it possible to increase the grip of a wheel 200 on difficult ground, for example snowy ground.

Conventionally, a wheel 200 has a rim 210 topped with a tire 220. The tire 220 has a tread 230 intended to come into contact with a ground.

The device 100 makes it possible to increase the grip of the wheel 200 by partially replacing the tread 230.

For this purpose, the device 100 comprises a main body 110 intended to come into contact with a wall of the rim 210, and a tread portion 120 intended to at least partially cover the tread 230 of the tire 220.

The tread portion 120 comprises a plurality of pads 121 intended to be distributed over the length of the tread 230 of the tire 200.

The pads 121 may comprise telescopic means for setting their width to adapt to the dimension of the wheel 200 on which the device 100 is mounted.

For increasing the grip of the wheel 200 on the ground, the tread portion 120 has grip means 130 formed by a plurality of protrusions 131.

The grip means 130 are located on an outer face 123 of the pad 121, opposite an inner face 122 intended to be facing the tread 230 of the tire 220.

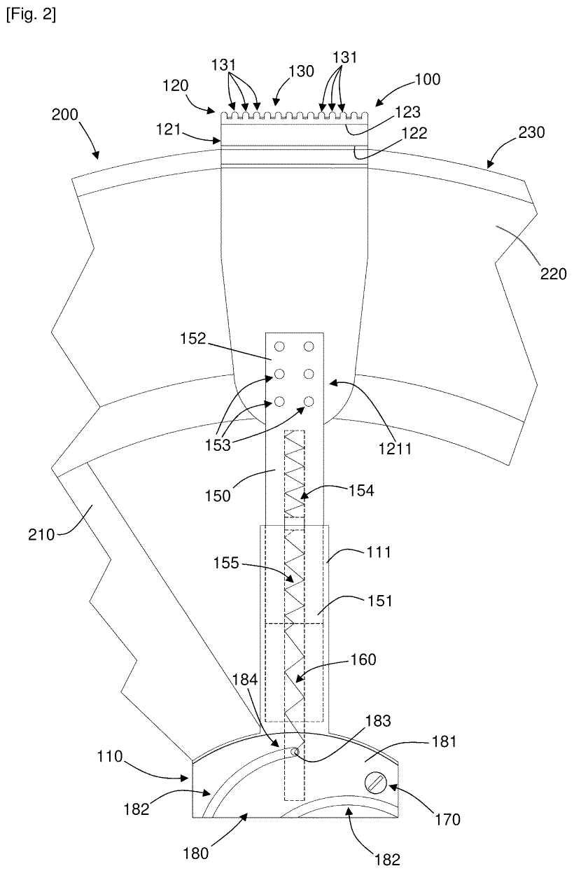

As can be seen in FIG. 2 in particular, the protrusions 131 form alternating troughs and peaks on the pad 121.

The recesses define grooves wherein soft ground material (for example snow or sand) can be housed in order to be discharged easily and thus increase the grip of the wheel 200.

With reference to FIG. 2 in particular, the device 100 also comprises a plurality of arms 150 connected to the main body 110 by a first end 151.

At a second end 152, opposite the first end 151, each arm 150 bears one of the pads 121.

The arms 150 thus form a junction between the main body 110 and the pads 121.

Each arm 150 is movable in translation on the main body 110 between:
a first position wherein the pads 121 are intended to be moved away from the tread 230 of the tire 220, and
a second position wherein the pads 121 are intended to be in contact with the tread 230 of the tire 220.

In the first position of the arms 150, the device 100 can thus easily be positioned on a wheel 200 or, on the contrary, be disengaged therefrom.

On the other hand, in the second position of the arms 150, the device 100 is integral with the wheel 200 by pressing the inner face 122 of the pads 121 on the tread 230 of the tire 220.

To guide each arm 150 in translation, the main body 110 comprises a plurality of sleeves 111 each receiving an arm 150.

The arms 150 are thus each slidably mounted in a sleeve 111.

Moreover, the device 100 comprises, for each arm 150, means 160 for returning the arm 150 to its second position.

The return means 160 are for example in the form of a spring which adopts a tensioned configuration when the arms 150 are in their first position, and a relaxed configuration when the arms 150 are in their second position.

In their relaxed configuration, the return means 160 retain a minimum tension to hold the arms 150 in their second position.

Moreover, as illustrated by FIG. 2, the arms 150 are connected to the sleeves 111 via a first return element 154 and a second return element 155.

The first return element 154 and the second return element 155 are calibrated identically, or almost identically, and are arranged such that they each exert a force in an opposite direction.

More specifically, the first return element 154 and the second return element 155 are compression springs. The first return element 154 is arranged to move the arm 150 in the sleeve 111 toward its first position, and the second return element 155 is arranged to move the arm 150 in the sleeve 111 toward its second position.

The first return element 154 and the second return element 155 make it possible to provide a functional clearance for the device 100.

Indeed, in the event of an isolated increase in the diameter of the tire 220, for example because of overinflation, or in the event of a localized decrease in the diameter of the tire 220, for example caused by passing an obstacle, the arm 150 may move slightly in the sleeve 111 under the influence of the first return element 154 or the second return element 155 in order to maintain contact between the pad 121 and the tire 220.

To keep it integral with the wheel 200, the device 100 comprises holding means 140.

More particularly, at least some of the pads 121 include the holding means 140. According to the embodiment illustrated in FIG. 1, all the pads 121 include the holding means 140.

The holding means 140 comprise, for each pad 121 bearing them, a flap 141 capable of adopting a clamping position wherein it extends transversely to the pad 121 and forms with the main body 110 and the pad 121 a clamping bridge intended to clamp the wheel 200.

Thus, in the first position of the arms 150, the pads 121 are intended to be moved away from the tread 230 of the tire 220, and the or each flap 141 is intended to be moved away from the wheel 200.

On the other hand, in the second position of the arms 150, the pads 121 are intended to be in contact with the tread 230 of the tire 220, and the or each flap 141 is intended to be in contact with the wheel 200.

To facilitate the positioning of the device 100 on a wheel 200, or its removal from a wheel 200, further, each flap 141 is rotatably mounted on a pad 121.

Relative to the pad 121, the flap 141 is then movable between a free position wherein the flap 141 extends the pad 121, and the clamping position to form the clamping bridge.

The flap 141 is in its free position in the first position of the arm 150, and in its clamping position in the second position of the arm 150.

Furthermore, the holding means 140 also comprise, for each flap 141, a spring strip 142 extending over the inner face 122 of the pad 121.

The strip 142 is intended to come into contact with the tread 230 of the tire 220 to control the movement of the flap 141 from its free position to its clamping position, or vice versa.

Indeed, the strip 142 is designed to pivot the flap 141 from its free position to its clamping position, simultaneously with switching the arm 150 from its first position to its second position.

For this purpose, the strip 142 has a curved shape defining an imprint which opens onto the inner face 122 of the pad 121.

When the arms 150 move from their first position to their second position, the pads 121 move closer to the tread 230, which triggers compression, and therefore elastic deformation, of the strip 142 between the tread 230 and the pad 121.

This compression then triggers the movement of the flap 141 from its free position to its clamping position by cooperation between the strip 142 and the flap 141.

Cooperation between the strip 142 and the flap 141 can be achieved by a sliding pivot link, for example. Any other ad hoc link may also be used.

On the other hand, when the arms 150 move from their second position to their first position, the pads 121 move away from the tread 230, and the strip 142 tends to cover its original curved shape, which triggers the switching of the flap 141 from its clamping position to its free position, again by cooperation between the strip 142 and the flap 141.

To ensure secure positioning of the device 100 on a wheel, each strip 142 bears a finger 143 intended to be inserted into a hole 124 made in the pad 121.

When the finger 143 is not housed in a hole 124, it then prevents switching of the arms 150 from their first position to their second position.

Indeed, the fingers 143 then form a stop which prevents the inner face 122 of the pad 121 from coming into contact with the tread 230 and therefore, consequently, prevents the arms 150 from reaching their second position.

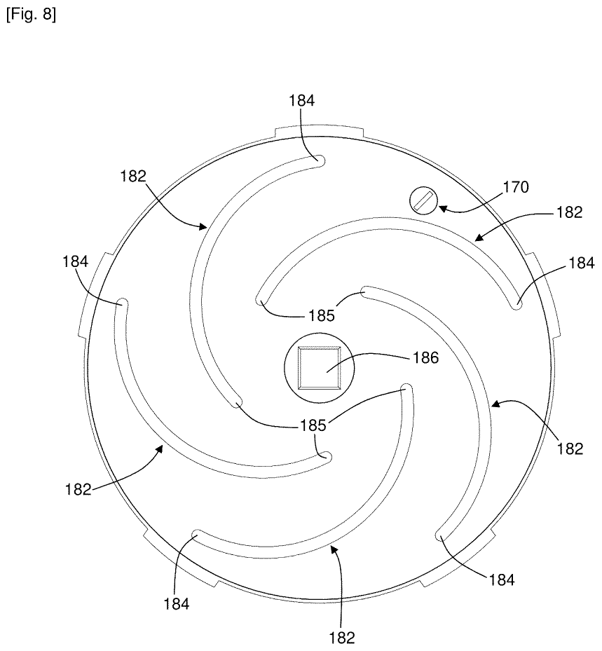

With reference to FIGS. 1 and 8, the device 100 also comprises means 180 for moving the arms 150.

The moving means 180 comprise a disk 181 rotatably mounted in the main body 110.

The disk 181 has, for each arm 150, a cam race 182, making it possible to act on the arms 150 to ensure their movement.

For this purpose, each arm 150 is coupled to a cam follower 183 intended to cooperate with one of the cam races 182.

Each cam race 182 has a first ending 184 spaced apart from a center of rotation of the disk 181 and corresponding to the first position of the arm 150, and a second ending 185 close to the center of rotation and corresponding to the second position of the arm 150.

In other words, when the disk 181 is moved in rotation, it moves each of the arms 150 between its first position and its second position by cooperation between the cam races 182 and the cam followers 183. When the cam followers 183 are located at the first ending 184 of the cam races 182, then the arms 150 are in their first position, and when the cam followers are located at the second ending 185 of the cam races 182, then the arms 150 are in their second position.

The device 100 further comprises a removable tool 300 intended to facilitate handling of the disk 181.

As can be seen in FIG. 1, the disk 181 has an imprint 186. The removable tool 300 has at least one end of complementary shape with the imprint 186 to allow rotation of the disk 181.

The imprint 186 may be hollowed in the disk 181 or, on the contrary, protrude from the disk 181.

To prevent its accidental removal from a wheel 200, the device 100 also comprises means 170 for locking each arm 150 in its second position.

As illustrated by FIGS. 1 and 8, the locking means 170 are in the form of a keyhole allowing the insertion of a key.

Thus, a lock mechanism (not seen in the figures) can be actuated by a key through the lock hole to engage a bolt with the body 110 and lock the disk 181 in rotation. This therefore makes it possible to immobilize the arms 150 in their second position.

Alternatively, the locking means 170 can prevent rotation of the disk 181. In this case, the locking means form an anti-theft device. When the key is removed, the anti-theft device is armed. A piece is then moved away from the body 110 by an elastic member so as to press it against the disk 181. When the arms 150 are in their second position, the disk 181 then has a housing wherein the piece is positioned to lock rotation of the disk 181. Only inserting the key can make it possible to unlock the anti-theft device.

In order to allow its adaptation to different diameters of wheels 200, the device 100 also comprises means for setting the position of the pads 121 on the second end 152 of the arms 150.

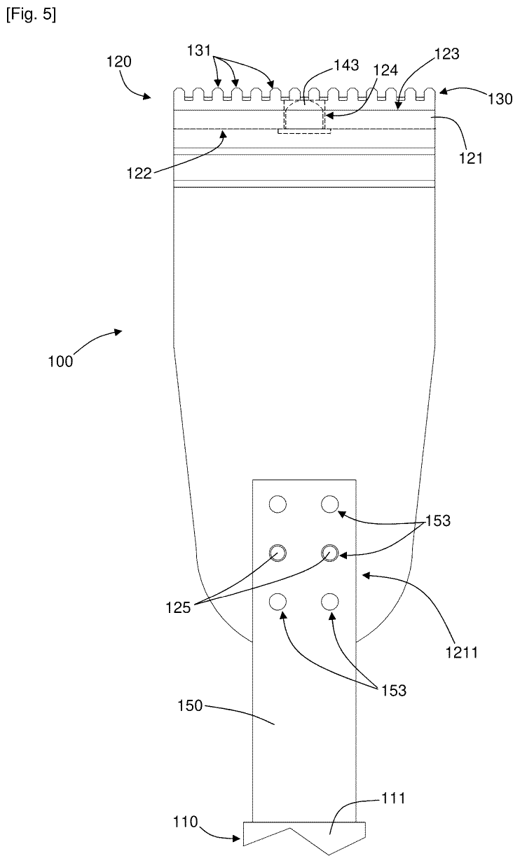

With reference to FIG. 5, the setting means comprise a series of housings 153 made on the arms 150, and at least one piece 125 integral with each pad 121 and intended to be housed in one of the housings 153.

More specifically, each pad 121 bears two pieces 125 each intended to be inserted into a housing 153.

Each piece 125 is for example elastically mounted on the pad 121 such that it can retract into the pad 121, against return members, to allow the movement of the pad 121 on the arm 150. When the pieces 125 are facing a housing 153, then return members push the pieces 125 back so as to protrude from the pad 121 to be housed in the housings 153 facing them.

By setting the position of the pads 121 on the arms 150, it is then possible to adapt the same device 100 on wheels 200 of different diameters.

In other words, the setting means make it possible to adapt the device 100 to a wheel 200 to ensure contact of the inner face 122 of the pads 121 with the tread 230, on one hand, and, adoption of the second position of the arms 150, i.e. arrival of the cam followers 183 in the second ending 185 of the cam races 182, on the other.

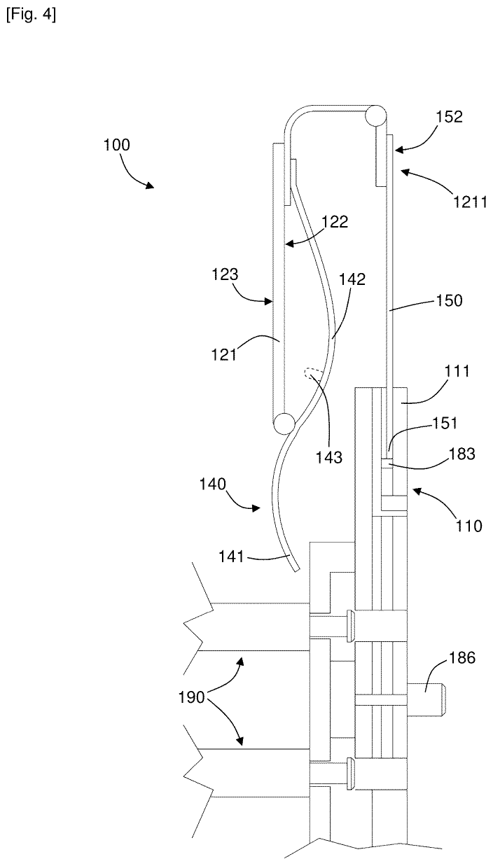

With reference to FIGS. 4, 6 and 7, the device 100 also comprises means 190 for fastening to a rim 210, the fastening means 190 comprising studs 191 intended to cooperate with screws for fastening the rim 210 to a hub.

The studs 191 are integral with the main body 110, for example by screwing, and are adjustable in depth to allow adaptation of the device to the width of the wheel 200.

More particularly, the adjustment in depth of the studs 191 makes it possible to move the main body 110 away from or closer to the wall of the rim 210 such that the flaps 141 press on the inside of the wheel 200 in the second position of the arms 150.

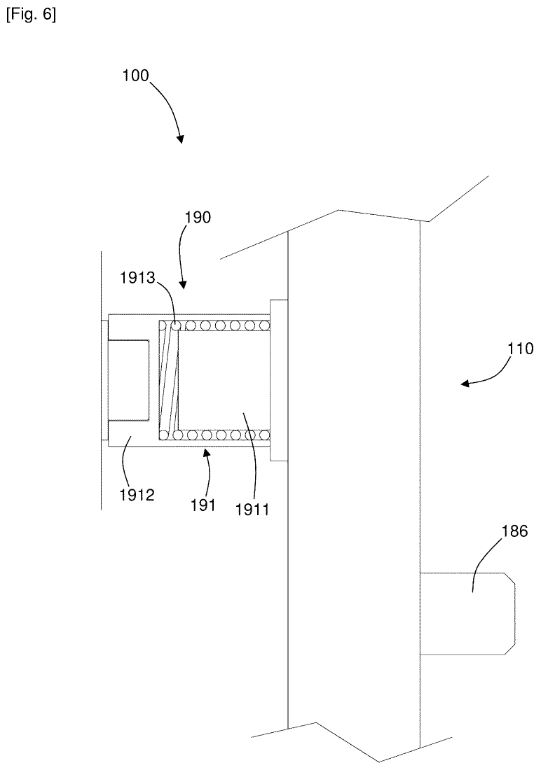

A first embodiment of the fastening means 190 is illustrated by FIG. 6.

In this first embodiment, the stud 191 comprises a rod 1911 integral with the main body 110, and a bushing 1912 mounted on the rod 1911. A spring 1913 is mounted around the rod 1911, in the bushing 1912, to separate the bushing 1912 from the main body 110. Ad hoc means for retaining the bushing 1912 on the main body 110 may be provided to limit the travel of the bushing 1912 along the rod 1911.

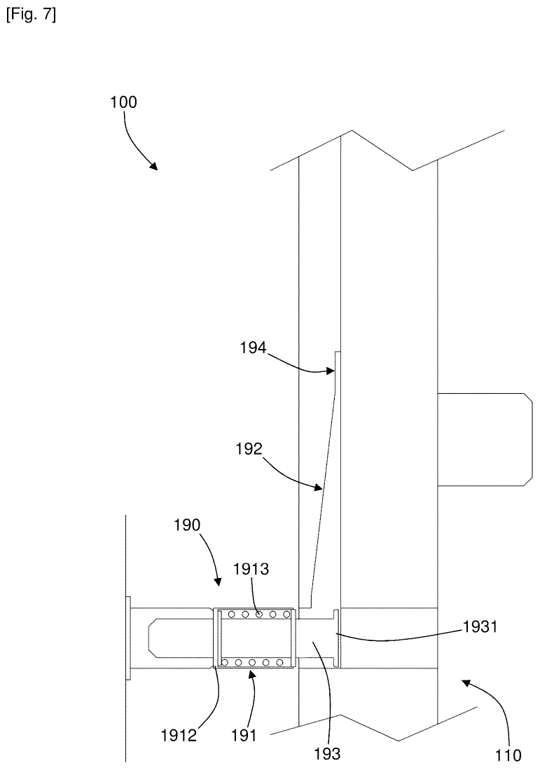

A second embodiment of the fastening means 190 is illustrated by FIG. 7.

In this second embodiment, the stud 191 is used to replace the studs for fastening the wheels 200 of the vehicle.

The stud 191 thus comprises the bushing 1912 inside which a retaining part is movably mounted.

The retaining part 193 has a head 1931 intended to cooperate with a retaining member 192 integral with the main body 110.

The retaining member 192 takes for example the form of an inclined groove made in a secondary disk and opening into a cavity 194 for receiving the head 1931, also made in the secondary disk, the secondary disk bearing the cavity 194 being located in the main body 110.

The inclined groove forming the retaining member 192 is advantageously circular such that, during positioning of the device 100, a rotation of the main body causes locking of the head 1931 in the cavity 194.

The disk 181 and the secondary disk are then linked to each other such that handling the imprint 186 triggers simultaneous rotation of the disk 181 and the secondary disk.

When the device 100 is fitted and the arms 150 are in their second position, the fastening means 190 make it possible to move the main body 110 away (for the first embodiment illustrated by FIG. 6) or closer (for the second embodiment illustrated by FIG. 7) in respect of the wall of the rim 210 to ensure contact between the flap 141 and the inside of the wheel 200, which ensures the hold of the device 100 on the wheel 200.

According to a simplified variant, not illustrated by the figures, the device 100 is devoid of fastening means 190.

In this case, the hold of the device on a wheel 200 is carried out by clamping, i.e. when the arms 150 are in their second position such that the pads 121 are in contact with the tread 230 and the or each flap 141 is in contact with the wheel 200.

In operation, a user positions the device 100 on a wheel 200.

More specifically, the user positions the main body 110 against the wall of the rim 210.

The user then engages the studs 191 with the nuts of the rim 210. Depending on the case, the user pivots the main body 110 so as to insert the heads 1931 into the cavities 194.

When the main body is positioned, the user uses the tool 300 to pivot the disk 181.

This has the effect of moving the arms 150 from their first position to their second position by cooperation between the cam followers 183, integral with the arms 150, and the cam races 182 made in the disk 181.

As the arms 150 move from their first position to their second position, the fingers 143 integral with the strips 141 are housed in the holes 124 made in the pads 121, which allows the inner face 122 of the pads to come against the tread 230.

At the same time, as the arms 150 move from their first position to their second position, the flaps 141 switch from their free position to their clamping position so as to clamp the wheel 200.

When the flaps 141 are in their clamping position and the arms 150 are in their second position, the user can then lock the arms 150 in position via the locking means 170, which prevents untimely removal of the device 100. The user can then store the tool 300 in their trunk and use their vehicle.

The outer face 123 of the pads 121 can then be used to increase the grip of the wheel 200 thanks to its grip means 130, so as to increase the drivability of the vehicle wherein the wheels 200 have just been equipped.

When the user seeks to remove the device 100 from a wheel 200, they follow the procedure in reverse.

The user unlocks the arms 150 via the locking means 170.

The user takes hold of the tool 300 to handle the disk 181 and trigger switching of the arms 150 from their second position to their first position.

This then causes, by the elasticity of the strip 142, switching of the flaps 141 from their clamping position to their free position.

When the flaps 141 are in their free position and the arms 150 are in their first position, the user can remove the device 100 from the wheel 200 and store it in their trunk, for example.

The device 100 that has just been described allows quick and simple fitting compared to the devices of the prior art.

Indeed, the user does not have to move their vehicle or enter the wheel housing to fasten the device 100 to the wheel 200.

Moreover, the device 100 is not at a risk of coming off the wheel 200 involuntarily thanks to the locking means 170.

Finally, the fingers 143 form a visual means for the correct fitting of the device on a wheel 200, which allows the user to use their vehicle in complete safety. Indeed, when the fingers 143 do not fit in their housings 124, the user immediately sees this and can remedy the problem to ensure the correct fitting of the devices 100 on the wheels 200.

An exemplary aspect of the disclosure overcomes the drawbacks of the prior art.

An exemplary aspect of the disclosure provides a removable grip device which is fitted simply, quickly, and independently of the state of wear of the tire.

An exemplary aspect of the disclosure provides such a device that is adaptable to different wheel sizes.

An exemplary aspect of the disclosure provides such a device which is secure and compact.

Although the present disclosure has been described with reference to one or more examples, workers skilled in the art will recognize that changes may be made in form and detail without departing from the scope of the disclosure and/or the appended claims.

1. A removable grip device for a motor vehicle wheel, the wheel having a rim topped with a tire having a tread, the device comprising:
a main body to come into contact with a wall of the rim;
a tread portion to at least partially cover the tread, said tread portion having a grip and a plurality of pads distributed over a length of the tread, at least some of the pads including a holder for holding the removable device on the wheel, the holder comprising a flap capable of adopting a clamping position wherein the flap extends transversely to the pad and forms with the main body and the pad a clamping bridge to clamp the wheel,
a plurality of arms connected to the main body by a first end and each bearing one of the pads at a second end, each arm being movable in translation on the main body between:
a first position wherein the pads are movable away from the tread and the or each flap is movable away from the wheel, and
a second position wherein the pads are contactable with the tread and the or each flap is contactable with the wheel.

2. The removable grip device according to claim 1, wherein the or each flap is rotatably mounted on a pad between a free position wherein the flap extends the pad, in the first position of the arm, and the clamping position to form the clamping bridge, in the second position of the arm.

3. The removable grip device according to claim 2, wherein the holder also comprises, for each flap, a spring strip extending on an inner face of the pad to come into contact with the tread, the strip being designed to pivot the flap from its free position to its clamping position, simultaneously with switching the arm from its first position to its second position.

4. The removable grip device according to claim 3, wherein each strip bears a finger to be inserted into a hole made in the pad to allow switching of the arms from their first position to their second position.

5. The removable grip device (100) according to claim 1, wherein the device also comprises a lock for locking each arm in the second position.

6. The removable grip device according to claim 1, wherein the main body comprises a plurality of sleeves each receiving an arm to guide the arm in translation relative to the main body.

7. The removable grip device according to claim 1, wherein the device also comprises, for each arm, a return element for returning the arm to the second position.

8. The removable grip device according to claim 1, wherein the device also comprises a positioner for setting a position of the pads on the second end of the arms.

9. The removable grip device according to claim 8, wherein the positioner comprises a series of housings made on the arms and at least one piece integral with each pad and housed in one of the housings.

10. The removable grip device according to claim 1, wherein the device comprises, for moving the arms, a disk rotatably mounted in the main body and having, for each arm, a cam race, each arm being coupled to a cam follower to cooperate with one of the cam races.

11. The removable grip device according to claim 10, wherein each cam race has a first ending spaced apart from a center of rotation of the disk and corresponding to the first position of the arm, and a second ending close to a center of rotation and corresponding to the second position of the arm.

12. The removable grip device according to claim 10, wherein the disk has an imprint and the device comprises a removable tool of complementary shape with the imprint to allow rotation of the disk.

13. The removable grip device according to claim 1, wherein the device also comprises a fastener for fastening to the rim, the fastener comprising studs to cooperate with screws for fastening the rim to a hub, the studs being adjustable in depth to allow adaptation of the device to a width of the wheel.

14. The removable grip device according to claim 1, wherein the grip comprises protrusions forming alternating troughs and peaks on the pad.
